(19) United States
(12) Patent Application Publication
(10) Pub. No.: US 2008/0213452 A1
(43) Pub. Date: Sep. 4, 2008

(54) ALL NATURAL SWEETENER COMPOSITIONS

(75) Inventors: Loren Miles, Los Angeles, CA (US); Chan Ma, Phillips Ranch, CA (US); Gina Rapo, Culver City, CA (US)

Correspondence Address: DUANE MORRIS LLP;IP DEPARTMENT, 190 South LaSalle Street, Suite 3700, CHICAGO, IL, 60603-3433, US

(73) Assignee: Loren Miles, Los Angeles, CA (US)

(21) Appl. No.: 12/035,690

(22) Filed: Feb. 22, 2008

Related U.S. Application Data
(63) Continuation-in-part of application No. 11/218,947, filed on Sep. 2, 2005.
(60) Provisional application No. 60/903,136, filed on Feb. 23, 2007.
(60) Provisional application No. 60/658,513, filed on Mar. 3, 2005.
(60) Provisional application No. 60/607,009, filed on Sep. 3, 2004.

(51) Int. Cl. A23L 1/307; A23L 1/236

(52) U.S. Cl. 426/548; 426/658

(57) ABSTRACT

The disclosure relates to zero- or low-calorie natural sweetener compositions including a polyol such as erythritol; a natural sweetener agent comprised of a blend of oligofructose, fructose, vegetable protein isolate, and natural flavors; bulking agents and calcium. The compositions are intended for use in beverages, foods and/or food and beverage products to replace or reduce high-calorie sweetener content and/or to provide dietary calcium supplementation.

### CROSS-REFERENCE TO RELATED APPLICATIONS

This application claims the benefit of priority to U.S. Provisional Patent Application Ser. No. 60/903,136, filed on Feb. 23, 2007. This application also claims the benefit of priority to, and is a continuation-in-part of; co-pending U.S. application Ser. No. 11/218,947, filed on Sep. 2, 2005; which claims the benefit of priority to U.S. provisional applications 60/658,513, filed on Mar. 3, 2005 and 60/607,009, filed on Sep. 3, 2004. The contents of each of which is incorporated herein by reference in its entirety.

### FIELD OF THE INVENTION

Aspects and embodiments of the present disclosure relate to natural sweetener compositions and preparations thereof. More specifically, the disclosure relates to zero- or low-calorie natural sweetener compositions including a polyol such as erythritol; a natural sweetener agent comprised of a blend of oligofructose, fructose, vegetable protein isolate, and natural flavors; maltodextrin and calcium. The compositions are intended for use in beverages, foods and/or food and beverage products to replace or reduce high-calorie sweetener content and/or to provide dietary calcium supplementation.

### BACKGROUND OF THE INVENTION

The following includes information that may be useful in understanding the present invention. It is not an admission that any of the information provided herein is prior art, or relevant, to the presently described or claimed inventions, or that any publication or document that is specifically or implicitly referenced is prior art.

High-fructose corn syrup, artificial sweeteners, sugar, obesity and diabetes are today's biggest health concerns. Health officials and scientists are beginning to understand in particular the link with high-fructose corn syrup, artificial sweeteners and sugar products to obesity, diabetes and numerous other health concerns. It is estimated that the average American consumes 20 teaspoons a day or more than 150 pounds of sugar per year. Teen consumption is higher at 34 teaspoons of sugar a day. Excessive consumption of sugar, especially by American youth, has experts calling the recent dramatic rise in type 2 diabetes among adolescents an “emerging epidemic.” Further, as a result of excessive refining, sugar is “devoid of vitamins, minerals and fiber.” According to statistics, 129 million adult Americans are overweight, over 60 million, or over 30% of the adult population, are obese. As a result of these health conditions, there are over 300,000 premature deaths each year. Over 40 million children, including “tweens” and teens are overweight. Many health experts assert that sugar is nutritionally empty and detrimental to human health and many believe it would fail the FDA approval process if such a hypothetical attempt were made today. According to Dr. Robert C. Atkins, founder of the popular Atkins diet, “sugar has no nutritional value and is directly harmful to your health. Despite vociferous attempts to defend it, there are studies that clearly show how harmful (and even deadly in the case of diabetics) its effects can be.” According to Nancy Appleton, PhD, author of “Lick the Sugar Habit,” there are 78 metabolic consequences of consuming sugar.

Diabetes however, is really only one of the numerous consequences of over-consuming sugar. Dr. John Yudkin, a leading authority on dietary sugars, says that the detrimental effects of excess sugar in the diet go far beyond rotting teeth and obesity. “For example,” Yudkin says, “sugar causes irregularities in the insulin response; sugar causes diabetes-like damage to the kidneys; it contributes to degeneration of the retina; it raises blood fat levels and it increases the stickiness of the blood platelets, a common precursor of heart trouble.”

Another health concern today is the lack of calcium supplementation. As we age, our need for certain minerals such as calcium increase due to the lower absorption rate of our aging digestive organs. The lack of adequate calcium and the minerals necessary for calcium's proper absorption have been associated with osteoporosis, colitis, bone fractures, dental health problems, brittleness of nails, insomnia, and bruxism. The body cannot produce calcium, yet it plays a vital role in daily body functions like muscle contraction, relaxation, blood clotting and the transmission of nerve impulses.

The calcium in bones is in a constant state of turnover. When diet does not provide enough, the body draws on the calcium stored in bone to maintain adequate blood levels. Not consuming enough calcium daily can drain calcium from bones, leading to osteoporosis. There is also emerging research evidence that suggests that calcium supplementation can assist in weight-loss.

The most effective way to achieve and sustain healthful weight-loss is by reducing calorie intake. Unfortunately, most humans instinctively are attracted to the sensation of sweetness which makes it more difficult for them to resist eating foods and beverages which contain high-caloric, high-glycemic sugars and sweeteners such as, for example, sucrose, fructose, honey and high-fructose corn syrup. Further, food manufacturers that produce low- or reduced-fat products often substantially increase the sugar or sweetener content of their products to offset the loss of taste and texture often associated with reducing fat content.

One avenue in an attempt to solve these serious health issues is the creation of a zero- or low-calorie sweetener or sugar substitutes that can be used in foods and/or beverages to replace or reduce high-calorie sweeteners and/or sugar content. Examples of such zero-calorie artificial sweeteners include, for example, aspartame, acesulfame-K, sucralose and saccharin. Low-calorie natural sweeteners would include lo han guo and stevia both derived from fruit and roots, respectively. However, not all zero- or low-calorie sweeteners or sugar substitutes, artificial or natural are suitable for all applications. For example, some sweeteners may be suitable for beverages such as sodas and drink mixes but are not acceptable for use in baked goods because exposure to higher temperatures during baking can reduce the sweetening ability of the sweetener. Some natural sweeteners have a bitter aftertaste and do not render a sweet enough taste or exist in a natural color such as brown or yellow, which conflicts with clear beverages or light colored baked products. As another example, some sweeteners may be suitable for use in solid foods or baked goods but may not work properly for use in beverages and drink mixes due to limitations on solubility or may not have GRAS status (generally recognized as safe as defined by the FDA).

In light of the aforementioned, there is a clear need and a demand for an all-natural sweetener composition that meets many of the health and commercial requirements.

### BRIEF SUMMARY OF THE INVENTION

The inventions described and claimed herein have many attributes and embodiments including, but not limited to, those set forth or described or referenced in this brief summary. It is not intended to be all-inclusive and the inventions described and claimed herein are not limited to or by the features or embodiments identified in this brief summary, which is included for purposes of illustration only and not restriction.

Accordingly, aspects and embodiments of the present disclosure provide natural, zero- or low-calorie natural sweetener compositions and preparations thereof that can be used in food products, including baked goods, snack goods, dairy goods and/or beverages and beverage mixes to replace or reduce high-calorie sugar or sugar sweetener content.

In certain aspects, the disclosure provides an all natural sweetener composition that tastes, bakes and cooks like sugar; is low-glycemic and/or diabetic-friendly; reduces the risk of tooth decay; contains less than 1 gram of carbohydrates per serving; and/or provides dietary calcium supplementation.

The general object of certain embodiments of the present invention can be attained, at least in part, through an all natural sweetener composition including a polyol, such as erythritol, an all natural sweetener agent comprised of a blend of oligofructose, fructose, vegetable protein isolate, and natural flavors, maltodextrin, isomaltulose (a low-calorie disaccharide derived from sucrose) and calcium. And to achieve an enhanced baking performance nearly identical to that of cane sugar, natural, organic cane sugar (sucrose) may be added to the above referenced ingredients.

In accordance with certain preferred embodiments, the all natural sweetener composition includes erythritol, a blend of oligofructose, fructose, vegetable protein isolate, and natural flavors, maltodextrin, isomaltulose, calcium and natural cane sugar (sucrose).

In accordance with certain other preferred embodiments, the all natural sweetener composition that delivers baking performance nearly identical to that of cane sugar includes about 25 to about 35 natural organic cane sugar (sucrose), about 30 to about 40 composition weight percent erythritol, about 1 to about 12 composition weight percent of a blend of oligofructose, fructose, vegetable protein isolate, and natural flavors, and about 25 to about 35 composition weight percent isomaltulose, and about 2 to about 12 composition weight percent calcium.

In accordance with a further preferred embodiment of the invention, the all natural sweetener composition includes about 27.825 composition natural organic cane sugar, 35.856 composition weight percent erythritol, about 4.864 composition weight percent of a blend of oligofructose, fructose, vegetable protein isolate, and natural flavors, about 27.825 composition weight percent isomaltulose, and about 3.63 composition weight percent of calcium.

In accordance with another embodiment of the present invention, an all natural sweetener composition for the primary use in baking food products includes about 1 to about 35 composition weight percent erythritol, preferably about 5 to about 15 composition weight percent erythritol; about 65 to about 95 composition weight percent a blend of oligofructose, fructose, vegetable protein isolate, and natural flavors, preferably about 78 to about 88 composition weight percent a blend of oligofructose, fructose, vegetable protein isolate, and natural flavors; about 1 to about 20 composition weight percent maltodextrin, preferably about 2 to about 12 composition weight percent maltodextrin; and about 1 to about 20 composition weight percent calcium, preferably about 2 to about 8 composition weight percent calcium.

In accordance with another embodiment of the invention, the all natural sweetener composition includes about 10.44 composition weight percent erythritol, about 82.40 composition weight percent of a blend of oligofructose, fructose, vegetable protein isolate, and natural flavors, about 4.75 composition weight percent maltodextrin, and about 2.37 composition weight percent of calcium.

Other objects and advantages will be apparent to those skilled in the art from the following description.

### DETAILED DESCRIPTION OF THE INVENTION

Aspects and embodiments of the disclosure will be set forth in part in the following description, unless otherwise defined, all technical and scientific terms and abbreviations used herein have the same meaning as commonly understood and known by one of ordinary skill in the art to which this invention pertains. Although methods and compositions similar or equivalent to those described herein can be used in practice of the present invention, suitable methods and compositions are described without intending that any such methods and compositions limit the invention herein.

General Aspects:

Although natural caloric sweetener compositions, such as sucrose, fructose, and glucose, provide the most desirable taste to consumers, they are caloric in nature. A numerous natural and synthetic high-potency sweeteners are non-caloric; however, some exhibit sweet tastes that have different temporal profiles (e.g. onset, duration), maximal responses, flavor profiles, mouthfeels, and/or adaptation behaviors than that of sugar. It is well known to those skilled in the art of food/beverage formulation that optimal development of the sweetener in a composition requires re-balancing of the flavor and other taste components.

Thus, it is particularly desirable in the production of sweeteners and sugar substitutes to develop sweeteners and sweetener compositions that are as similar as possible to sugar in texture, taste, and usability. More specifically, it is particularly desirable to develop sweeteners and sweetener compositions that provide an appropriate level of sweetness, have an appropriate texture and mouthfeel, have a positive impact on product appearance, have limited or no negative aftertaste, and provide flavor enhancing and/or masking abilities, stability, and the ability to rise, caramelize (brown), and to provide a crust when baked, and to preserve and taste similar to cane sugar taste profile. However, due to the varying properties of different sweetening ingredients, it is often difficult to achieve as satisfactory of a result when combining such ingredients. This is generally believed to be due to the synergistic effects of mixing various sweetening compounds wherein the sweetness of the mixture is often greater than the apparent sweetness of the individual components.

The instant disclosure is directed to the discovery that an appropriate blend of a polyol such as erythritol, a reduced-calorie sweetener such as a blend of oligofructose, fructose, vegetable protein isolate, and natural flavors, and maltodextrin, isomaltulose and natural, organic cane sugar (sucrose) and/or calcium can result in sweetener product that has many of the desirable properties of sugar and supplementing the body with calcium, an essential mineral for bone and general health support.

In certain embodiments, the instant disclosure provides a zero- or low-calorie all natural sweetener composition suitable for use in beverages, food products and/or the baking of food products, as it is designed to achieve an enhanced baking profile and properties nearly identical to that of cane sugar. Such an all natural sweetener composition includes a polyol, such as, for example, erythritol; a reduced-calorie sweetener such as a blend of oligofructose, fructose, vegetable protein isolate, natural flavors, maltodextrin, isomaltulose, and calcium supplementation and natural, organic cane sugar (sucrose).

Another certain embodiment of the present invention further provides an all-natural sweetener composition having zero or low in calories per serving and may depending on the amount used, contain less than 1 gram of carbohydrates per serving.

Yet another certain embodiment of the present invention additionally provides an all-natural sweetener composition that tastes like sugar, bakes like sugar, is low-glycemic and diabetic-friendly, and may reduce the risk of tooth decay.

In addition, emerging clinical research suggests that calcium absorption is enhanced by the presence of oligofructose derived from inulin. One such study reported that girls and boys aged between 9 and 12 supplemented with a mixture of oligofructose and long-chain inulin had an additional net accretion of calcium of 30 milligrams per day, compared to the controls who received a placebo (American Journal of Clinical Nutrition, 2005, Vol. 82, pp. 471-476). Furthermore, osteoporosis is estimated to affect about 75 million people in Europe, the USA and Japan. According to the International Osteoporosis Foundation, the total annual direct cost of osteoporotic fractures is $17.5 billion in the US (2002 figure).

Accordingly, aspects and embodiments of the instant disclosure provide a sweetener composition which further comprises calcium as dietary supplement.

### DEFINITIONS

As used herein, “baked food” or “baked good” comprises the all-natural sweetener compositions of the instant disclosure. “Baked goods” or “baked food products” can include ready to eat and all ready to bake products, flours, and mixes requiring preparation before serving. Non-limiting examples of baked goods include cakes, crackers, cookies, brownies, muffins, rolls, bagels, donuts, strudels, pastries, croissants, biscuits, bread, bread products, and buns. As used herein, “baked food or goods” can be classified into at least three groups: bread-type doughs (e.g., white breads, variety breads, soft buns, hard rolls, bagels, pizza dough, and flour tortillas), sweet doughs (e.g., danishes, croissants, crackers, puff pastry, pie crust, biscuits, and cookies), and batters (e.g., cakes such as sponge, pound, devil's food, cheesecake, and layer cake, donuts or other yeast raised cakes, brownies, and muffins). Doughs generally are characterized as being flour-based, whereas batters are more water-based. In addition, “baked goods” generally comprise a combination of sweetener, water, and fat. Baked goods can also contain flour in order to make a dough or a batter. The term “dough” as used herein is a mixture of flour and other ingredients stiff enough to knead or roll. The term “batter” as used herein consists of flour, liquids such as milk or water, and other ingredients, and is thin enough to pour or drop from a spoon.

The type of flour may be selected based on the desired food or baked goods product. Generally, the flour comprises an edible non-toxic flour that is conventionally utilized in baked goods. According to particular embodiments, the flour may be a bleached bake flour, general purpose flour, or unbleached flour. In other embodiments, flour may be enriched with additional vitamins, minerals, or proteins. Non-limiting examples of flours suitable for use in particular embodiments of the invention include wheat, corn meal, whole grain, fractions of whole grains (wheat, bran, and oatmeal), and combinations thereof. Starches or farinaceous material also may be used as the flour in particular embodiments. Common food starches generally are derived from potato, corn, wheat, barley, oat, tapioca, arrow root, and sago. Modified starches and pre-gelatinized starches also may be used in particular embodiments.

Baked goods may also comprise a number of additional conventional ingredients such as leavening agents, flavors, colors, milk, milk by-products, egg, egg by-products, cocoa, vanilla or other flavoring, as well as inclusions such as nuts, raisins, cherries, apples, apricots, peaches, other fruits, citrus peel, preservative, coconuts, flavored chips such a chocolate chips, butterscotch chips, and caramel chips, and combinations thereof. Leavening agents may comprise chemical leavening agents or yeast leavening agents. Non-limiting examples of chemical leavening agents suitable for use in particular embodiments of this invention include baking soda (e.g., sodium, potassium, or aluminum bicarbonate), baking acid (e.g., sodium aluminum phosphate, monocalcium phosphate, or dicalcium phosphate), and combinations thereof.

As used herein, taste improving compositions can impart positive affects on the taste profile can include elimination or reduction of the “undesirable taste,” which includes any taste property which is not imparted by sugars, e.g. glucose, sucrose, fructose, or similar saccharides. Non-limiting examples of undesirable tastes include delayed sweetness onset, lingering sweet aftertaste, metallic taste, bitter taste, cooling sensation taste or menthol-like taste, licorice-like taste, and/or the like.

As used herein, the sweetener compositions of the instant disclosure can also optionally combined if desired with additional “taste improving compositions.” Exemplary components can include other carbohydrates, amino acids and their corresponding salts, poly-amino acids and their corresponding salts, sugar acids and their corresponding salts, nucleotides, organic acids, inorganic acids, organic salts including organic acid salts and organic base salts, inorganic salts, bitter compounds, flavorants and flavoring ingredients, astringent compounds, proteins or protein hydrolysates, surfactants, emulsifiers, flavonoids, alcohols, polymers, other sweet taste improving taste additives imparting such sugar-like characteristics, and combinations thereof.

As used herein “nutritive sweeteners” can include, for example, Sucrose (table sugar), Sugarcane; Sugar alcohols; Honey; Fruits; Syrups, including, for example, Maple syrup, Sugar beet syrup, Corn syrup, Cane syrup, Golden syrup, Barley malt syrup, Molasses (treacle), Brown rice syrup, and Agave syrup.

As used herein, “non-nutritive sweeteners” can include, for example, Acesulfame potassium, also known as Sunett®; Alitame, also known as Aclame®; Aspartame, also known as Equal® or Nutrasweet®; Cyclamate; Glycyrrhizin; Lo han guo; Neotaume; Nerillartine; Saccharin, also known as Sweet “n” Low®; Stevioside; Sucralose, also known as Splenda®.

As used herein, “sugar” may include sucrose, lactose, and/or fructose.

As used herein, “polyol” (also known as “sugar alcohol”, polyhydric alcohol, or polyalcohol) can be characterized in whole or in part by the presence of a hydrogenated form of carbohydrate, whose carbonyl group (e.g. aldehyde or ketone, reducing sugar) has been reduced to a primary or secondary hydroxyl group. Polyols have the general formula: H(HCHO)ₙ₊₁H, whereas sugars is H(HCHO)ₙHCO. Polyols do not contribute to tooth decay when used in food preparation as they are not metabolized by the bacteria in the mouth. In certain aspects, polyols can be used in combination with additional ingredients or agents which contribute complementary gygroscopic, crystalline, and/or heat of solution (warming effect when dissolved that helps cancel e.g. erythritols cooling effect) characteristics. Exemplary sugar alcohols may include Glycol, Glycerol, Erythritol, Arabitol, Xylitol, Ribitol, Mannitol, Sorbitol, Isomalt, Maltitol, and Lactitol. In certain embodiments, erythritol is the preferred polyol. Disaccharides and monosaccharides can both form exemplary sugar alcohols; however, sugar alcohols derived from disaccharides (e.g. maltitol and lactitol) are not entirely hydrogenated because only one aldehyde group is available for reduction.

As used herein, the all natural sweetener composition comprises of a blend of oligofructose, fructose, vegetable protein isolate, and natural flavors (e.g. orange fruit peels).

Sweetener composition 1:

In accordance with an embodiment of the present invention, an all natural sweetener composition for the primary use in baking food products where the taste and qualities of cane sugar are nearly identical, such as with the use of heat, browning, (Maillard reaction), and crystallization (hardening of the sweetener), includes a polyol, such as erythritol, a blend of oligofructose, fructose, vegetable protein isolate, natural flavors, isomaltulose (a low-caloric disaccharide derived from sucrose) and calcium is provided. In particular, the natural sweetener composition includes:

about 15 to about 45 composition weight percent erythritol, preferably about 27 to about 37 composition weight percent erythritol;

about 1 to about 30 composition weight percent a blend of oligofructose, fructose, vegetable protein isolate, and natural flavors, preferably about 1 to about 10 composition weight percent a blend of oligofructose, fructose, vegetable protein isolate, and natural flavors;

about 10 to about 35 composition weight percent isomaltulose, preferably about 10 to about 30 composition weight percent isomaltulose;

about 1 to about 10 composition weight percent calcium, preferably about 2 to about 7 composition weight percent calcium; and

about 15 to about 65 composition weight percent natural, organic cane sugar (sucrose), preferably about 25 to about 35 composition weight natural, organic cane sugar (sucrose).

Preferably, the all natural sweetener composition may include additional ingredients, compounds or sweeteners which may enhance the flavor, stability, and processability of the sweetener composition. For example, the all natural sweetener composition may include an additional sweetener such as a reduced-calorie sweetener, a sugar-derived sweetener, or a non-nutritive sweetener. Additionally, the natural sweetener composition may include a processing and/or stability aids such as, for example, silica and/or other flow or preservative agents.

One of ordinary skill in the art, with the teachings of the present invention, may arrive at all the possible combinations as contemplated herein. For example, the natural sweetener composition can includes: about 20 to about 45, about 30 to about 41, about 35 to about 36 composition weight percent erythritol; about 1 to about 8, about 2 to about 7, about 4.5 to about 5.5 composition weight percent of a blend of oligofructose, fructose, vegetable protein isolate, and natural flavors; about 15 to about 30, about 20 to about 30, about 27 to about 28 composition weight percent isomaltulose; about 3 to about 4 composition weight percent calcium; and about 20 to about 60, about 25 to about 55, about 25 to about 30, about 26 to about 29, about 27 to about 28 composition weight natural, organic cane sugar (sucrose).

### EXAMPLE 1

Enhanced Baking Version

| | Composition | Single Serving |
|---|---|---|
| Ingredient | Weight Percent | Weight (4.0 g) |
| Natural, organic cane | 27.825% | 1.113 |
| sugar (sucrose) | | |
| Erythritol | 35.856 | 1.434 |
| Blend ofoligofructose, fructose, | 4.864 | 0.19456 |
| vegetable protein isolate, | | |
| and natural flavors | | |
| Isomaltulose | 27.825 | 1.113 |
| Calcium | 3.630 | 0.1452 |

Sweetener Composition 2:

Further, in accordance with certain preferred embodiments of the present invention, an all natural sweetener composition for the primary use in commercial food and beverage product applications where the taste and qualities of cane sugar are nearly identical, such as with the use of heat, browning, (maillard reaction), and crystallization (hardening of the sweetener), high heat beverage processing, however, at ten times the sweetness of cane sugar, offers greater cost efficiency, includes an appropriate blend of a polyol such as erythritol, a reduced-calorie sweetener, a blend of oligofructose, fructose, vegetable protein isolate, and natural flavors, maltodextrin, and calcium, can result in sweetener product that has many of the desirable properties of sugar without the added calories.

In accordance with certain embodiments of the present invention, an all natural sweetener composition for use in beverages and/or food products includes erythritol, a blend of oligofructose, fructose, vegetable protein isolate, and natural flavors and maltodextrin and calcium. In particular, the natural sweetener composition includes:

about 1 to about 35 composition weight percent erythritol, preferably about 5 to about 15 composition weight percent erytbritol;

about 65 to about 95 composition weight percent a blend of oligofructose, fructose, vegetable protein isolate, and natural flavors, preferably about 78 to about 88 composition weight percent a blend of oligofructose, fructose, vegetable protein isolate, and natural flavors;

about 1 to about 20 composition weight percent maltodextrin, preferably about 2 to about 12 composition weight percent maltodextrin; and

about 1 to about 20 composition weight percent calcium, preferably about 2 to about 8 composition weight percent calcium.

Preferably, the all-natural sweetener composition may include additional ingredients, compounds or sweeteners which may enhance the flavor, stability, and processability of the sweetener composition. For example, the all-natural sweetener composition may include an additional sweetener such as a reduced-calorie sweetener, a sugar-derived sweetener, or a non-nutritive sweetener. Additionally, the natural sweetener composition may include a processing and/or stability aids such as, for example, silica and/or other flow or preservative agents.

One of ordinary skill in the art, with the teachings of the present invention, may arrive at all the possible combinations as contemplated herein. For example, the natural sweetener composition can includes: about 8 to about 12, about 10 to about 11 composition weight percent erythritol; about 80 to about 85, about 82 to about 83 composition weight percent of a blend of oligofructose, fructose, vegetable protein isolate, and natural flavors; about 2 to about 6, about 4 to about 5, composition weight percent maltodextrin; and about 2 to about 4, about 2 to about 3 composition weight percent calcium.

### EXAMPLE 2

Commercial 10x Version

| | Composition | |
|---|---|---|
| | Weight Percent | Single Serving |
| Ingredient | (%) | Weight (e.g 2.66 g) |
| Erythritol | 10.44 | 1.59 |
| Blend of | 82.40 | 0.8 |
| oligofructose, fructose, | | |
| vegetable protein isolate, | | |
| and natural flavors | | |
| Maltodextrin | 4.75 | 0.18 |
| Calcium | 2.37 | 0.09 |

Special Blending Protocol in the Manufacturing Process:

To achieve the full benefit of the sweetness level intended and for all of characteristics to be fully realized for these products that the smallest amount ingredient be mixed with the next larger amount until fully blended. Then the next largest ingredient is then added to the combined blend until it is fully dispersed. Then the next largest ingredient is added after that, and this protocol is continued until all ingredients are blended. This assures maximum dispersion of all elements.

In certain instances, the exemplary compositions of the instant disclosure can be formulated or prepared by a special process to prevent or reduce undesired environmental factors (e.g moisture penetration) from adversely affecting the taste, appearance and/or flow-ability characteristics of the composition as originally intended. Suitable process and/or method can include, for example, applying and/or dispersing an aerosolized solution containing, for example, preserving agents, such as glycerin, silica, corn or rice derived product such that when applied to the compositions and/or components thereof of the instant disclosure, the intended taste, appearance, and/or flow-ability of the compositions disclosed herein are preserved. In certain embodiments, said solution is applied while the sweetener compositions are placed in a suitable receiving platform, such as, for example, a fluidized-bed dryer.

While in the foregoing specification this invention has been described in relation to certain preferred embodiments thereof and many details have been set forth for purposes of illustration, it will be apparent to those skilled in the art that the all natural sweetener composition according to this invention is susceptible to additional embodiments and that certain of the details described herein can be varied significantly without departing from the basic principles of the invention.

All patents, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety. Applicants reserve the right to physically incorporate into this specification any and all materials and information from any such patents, publications, scientific articles, web sites, electronically available information, and other referenced materials or documents.

Those of skill in the art, in light of the present disclosure, will appreciate that obvious modifications of the embodiments disclosed herein can be made without departing from the spirit and scope of the invention. All of the embodiments disclosed herein can be made and executed without undue experimentation in light of the present disclosure. The full scope of the invention is set out in the disclosure and equivalent embodiments thereof. The specification should not be construed to unduly narrow the full scope of protection to which the present invention is entitled.

While a particular embodiment of the invention has been shown and described, numerous variations and alternate embodiments will occur to those skilled in the art. Accordingly, it is intended that the invention be limited only in terms of the appended claims.

The invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes to the claims that come within the meaning and range of equivalency of the claims are to be embraced within their scope.

Other embodiments are within the following claims. In addition, where features or aspects of the invention are described in terms of Markush groups, those skilled in the art will recognize that the invention is also thereby described in terms of any individual member or subgroup of members of the Markush group.

What is claimed is:

1. A sweetener composition comprising:
about 15 to about 65 composition weight percent natural cane sugar (sucrose);
about 15 to about 45 composition weight percent polyol;
about 1 to about 30 composition weight percent of a blend of oligofructose, fructose, vegetable protein isolate, and natural flavors;
about 10 to about 35 composition weight percent isomaltulose; and
about 1 to about 10 composition weight percent calcium.

2. The sweetener composition of claim 1, wherein the polyol is selected from the group consisting of erythritol, maltitol, lactitol, palatinit, sorbitol, manitol, xylitol and combinations thereof.

3. The sweetener composition of claim 1, wherein the polyol is erythritol.

4. The sweetener composition of claim 1, wherein the composition comprises about 25 to about 35 composition weight percent natural cane sugar (sucrose).

5. The sweetener composition of claim 1, wherein the composition comprises about 37 to about 47 composition weight percent erythritol.

6. The sweetener composition of claim 1, wherein the composition comprises about 1 to about 10 composition weight percent of a blend of oligofructose, fructose, vegetable protein isolate, and natural flavors.

7. The sweetener composition of claim 1, wherein the composition comprises about 10 to about 30 composition weight percent isomaltulose.

8. The sweetener composition of claim 1, wherein the composition comprises about 2 to about 7 composition weight percent calcium.

9. The sweetener composition of claim 1 consisting essentially of: about 35 to about 36 composition weight percent erythritol; about 4 to about 5 composition weight percent of a blend of oligofructose, fructose, vegetable protein isolate, and natural flavors;
about 27 to about 28 composition weight percent isomaltulose; about 3 to about 4 composition weight percent calcium; and about 27 to about 28 composition weight percent natural cane sugar.

10. A sweetener composition comprising:
about 1 to about 35 composition weight percent erythritol,
about 65 to about 95 composition weight percent a blend of oligofructose, fructose, vegetable protein isolate, and natural flavors;
about 1 to about 20 composition weight percent maltodextrin; and
about 1 to about 20 composition weight percent calcium.

11. The sweetener composition of claim 10, wherein the composition comprises about 5 to about 15 composition weight percent erythritol.

12. The sweetener composition of claim 10, wherein the composition comprises about 78 to about 88 composition weight percent a blend of oligofructose, fructose, vegetable protein isolate, and natural flavors.

13. The sweetener composition of claim 10, wherein the composition comprises about 2 to about 12 composition weight percent maltodextrin.

14. The sweetener composition of claim 10, wherein the composition comprises about 2 to about 8 composition weight percent calcium.

15. The sweetener composition of claim 10 consisting essentially of: about 10.44 composition weight percent erythritol, about 82.40 composition weight percent of a blend of oligofructose, fructose, vegetable protein isolate, and natural flavors, about 4.75 composition weight percent maltodextrin, and about 2.37 composition weight percent of calcium.

16. A method for making a sweetener composition comprising; preparing a blend of a polyol, a natural cane sugar (sucrose); a blend of oligofructose, fructose, vegetable protein isolate, and natural flavors; an isomaltulose; a maltodextrin, and/or a calcium.

17. The method of claim 16, wherein the blend comprises of about 35 to about 36 composition weight percent erythritol; about 4 to about 5 composition weight percent of a blend of oligofructose, fructose, vegetable protein isolate, and natural flavors; about 27 to about 28 composition weight percent isomaltulose; about 3 to about 4 composition weight percent calcium; and about 27 to 28 composition weight percent natural cane sugar.

18. The method of claim 16, wherein the blend comprises of about 10.44 composition weight percent erythritol, about 82.40 composition weight percent of a blend of oligofructose, fructose, vegetable protein isolate, and natural flavors, about 4.75 composition weight percent maltodextrin, and about 2.37 composition weight percent of calcium.

19. A baked good comprising a sweetener composition consisting essentially of: about 35 to about 37 composition weight percent erythritol; about 4 to about 5 composition weight percent of a blend of oligofructose, fructose, vegetable protein isolate, and natural flavors; about 27 to about 28 composition weight percent isomaltulose; about 3 to about 4 composition weight percent calcium; and about 27 to 30 composition weight percent natural cane sugar.

20. A blend mixture for commercial preparation of baked goods comprising a sweetener composition consisting essentially of: about 10.44 composition weight percent erythritol, about 82.40 composition weight percent of a blend of oligofructose, fructose, vegetable protein isolate, and natural flavors, about 4.75 composition weight percent maltodextrin, and about 2.37 composition weight percent of calcium.

21. The method of claim 16 comprising: applying to a sweetener composition an effective amount of an aerosolized solution comprising a preserving agents whereby the moisture penetration into said composition is reduced.
